(19) United States
(12) Patent Application Publication
(10) Pub. No.: US 2005/0150451 A1
(43) Pub. Date: Jul. 14, 2005

(54) Position adjusting method and substrate processing system

(75) Inventors: Michio Tanaka, Kikuchi-gun (JP); Masami Yamashita, Kikuchi-gun (JP)

Correspondence Address: RADER FISHMAN & GRAUER PLLC, LION BUILDING, 1233 20TH STREET N.W., SUITE 501, WASHINGTON, DC, 20036, US

(73) Assignee: Tokyo Electron Limited

(21) Appl. No.: 11/029,401

(22) Filed: Jan. 6, 2005

(30) Foreign Application Priority Data
Jan. 13, 2004 (JP) JP2004-005726

(51) Int. Cl. G03C 5/00; B05C 11/00

(52) U.S. Cl. 118/688; 118/663; 430/30

(57) ABSTRACT

According to the present invention, in a coating treatment apparatus comprising a rotary holding member and a coating solution discharge member, positional adjustment of the holding position of the substrate with respect to the rotary holding member and a discharge position of a coating solution discharge member is quickly and accurately performed, so that the time required for the positional adjustment can be shortened. Further, variations in accuracy of the positional adjustment depending on the degree of proficiency of operator can be eliminated, realizing positional adjustment with a high precision at all times.

### BACKGROUND OF THE INVENTION

1. Field of the Invention

The present invention relates to a position adjusting method and a substrate processing system in a coating treatment apparatus for applying a coating solution to a substrate.

2. Description of the Related Art

In a photolithography process in a manufacturing of a semiconductor device, for example, a plurality of treatments and processing are performed such as a resist coating treatment to form a resist film by applying a resist solution to the surface of a wafer, a developing treatment to develop the wafer undergone exposure processing, thermal processing to heat or cool the wafer to a predetermined temperature, and so on. These wafer treatments and processing are performed sequentially in a manner of a single wafer processing in a coating and developing treatment system in which a number of treatment and processing apparatuses are installed.

Further, in recent years, a coating and developing treatment system is proposed which includes a film thickness measuring apparatus for measuring the film thickness of the resist film formed on the wafer, a defect detector for detecting defects on the surface of the wafer, a line width measuring apparatus for measuring the line width of a pattern formed in the resist film, and so on. In this coating and developing treatment system, after the above-described plurality of treatments and processing are finished, a plurality of various kinds of inspection for the wafer are performed (Japanese Patent Laid-open No. 2003-218022 and Japanese Patent Laid-open No. 2002-190446).

Incidentally, the resist coating treatment performed in the above-described coating and developing treatment system is usually performed in a resist coating apparatus. The resist coating apparatus includes a spin chuck for mounting and holding the wafer thereon and rotating it and a resist solution discharge nozzle for discharging a resist solution from above the wafer. The resist coating treatment is performed by mounting the wafer on the spin chuck, rotating the spin chuck, and discharging the resist solution from the resist solution discharge nozzle to the center portion of the rotated wafer to thereby spread the resist solution over the entire of the wafer from the center part. In the above resist coating apparatus, if the holding position of the wafer or the discharge position of the resist solution discharge nozzle with respect to the spin chuck is displaced, the resist solution is not evenly spread over the wafer, thus forming a resist film with uneven thickness. Therefore, to apply the resist solution uniformly onto the wafer, it is necessary to perform so-called centering adjustment in which the mounting position of the wafer and the discharge position of the resist solution discharge nozzle are aligned with the rotation center of the spin chuck.

However, the centering adjustment in the above-described resist coating apparatus has been conventionally performed through visual check by an operator. In other words, whether the wafer is mounted such that the center of the wafer is aligned with the rotation center of the spin chuck and whether the resist solution discharge nozzle is located above the rotation center axis of the spin chuck are checked with the naked eye. If there is positional displacement, the operator estimates the positional displacement amount and performs correction in a trial-and-error manner for positional adjustment. Therefore, the centering adjustment takes much time, during which the apparatus cannot be operated, leading to a decrease in availability of the apparatus. Further, depending on the degree of proficiency of the operator, the positional adjustment is inaccurately performed, causing the problem of failing to ensure fixed accuracy at all times.

### SUMMARY OF THE INVENTION

The present invention has been developed in consideration of the above point and has an object to provide a position adjusting method and a substrate processing system, each capable of, in a coating treatment apparatus such as a resist coating apparatus for a substrate such as a wafer, performing quickly and accurately so-called centering adjustment of a holding position of the substrate and a coating solution discharge member such as a resist solution discharge nozzle.

To achieve the above object, the present invention includes the steps of: discharging a coating solution onto a center portion of a substrate and spreading the coating solution over a surface of the substrate while holding and rotating the substrate by a rotary holding member to thereby apply the coating solution to the surface of the substrate; then supplying a removal liquid for the coating solution onto an outer peripheral portion of the substrate from a removal liquid discharge member at a fixed position while rotating the substrate by the rotary holding member to thereby remove the coating solution at the outer peripheral portion in an annular shape; then capturing an image of the surface of the substrate; and measuring a width of the outer peripheral portion from which the coating solution has been removed, from the image of the surface of the substrate, deriving a positional displacement of a holding position of the substrate on the rotary holding member from the measured width of the outer peripheral portion, and adjusting the holding position of the substrate based on the positional displacement.

When the holding position of the substrate is displaced on the rotary holding member, the substrate rotated by the rotary holding member is decentered, and therefore the width of the coating solution at the outer peripheral portion of the substrate removed by the removal liquid discharge member at the fixed position varies along the circumferential direction of the substrate by the amount of displacement of the holding position. According to the present invention, the width of the outer peripheral portion is measured from the image, and from the width the displacement of the holding position of the substrate is derived. Then, based on the positional displacement the holding position of the substrate is adjusted. As described above, in the present invention, the displacement of the holding position of the substrate is derived relatively easily, so that the positional adjustment of the holding position of the substrate can be performed in a shorter time. Further, since the holding position of the substrate can be adjusted from information of the image, accurate positional adjustment can be performed irrespective of the degree of proficiency of operator.

According to another aspect of the present invention, the present invention includes the steps of: discharging a coating solution from a coating solution discharge member onto a center portion of a substrate and spreading the coating solution over a surface of the substrate while holding and rotating the substrate by the rotary holding member to thereby apply the coating solution to the surface of the substrate; then detecting a thickness distribution of the coating solution on the surface of the substrate; and specifying a discharge position of the coating solution discharge member on the surface of the substrate from the detected thickness distribution, deriving a positional displacement between the discharge position of the coating solution discharge member and a rotation center of the rotary holding member on the surface of the substrate, and adjusting the discharge position of the coating solution discharge member with respect to the rotary holding member based on the positional displacement.

When the discharge position of the coating solution discharge member is displaced from the rotation center of the rotary holding member, the thickness of the coating solution on the surface of the substrate at the discharge position of the coating solution discharge member differs from that at the other portions.

Therefore, the positional displacement between the rotation center of the rotary holding member and the discharge position of the coating solution discharge member is detected from the thickness distribution of the coating solution on the surface of the substrate, and the discharge position of the coating solution discharge member is adjusted based on the positional displacement, whereby the positional adjustment can be performed by a simple method and the positional adjustment of the coating solution discharge member can be performed in a short time. Further, since the discharge position of the coating solution discharge member can be adjusted from the information of the thickness distribution of the coating solution, accurate positional adjustment can be performed irrespective of the degree of proficiency of operator.

According to still another aspect of the present invention, the present invention includes the steps of: discharging a predetermined amount of coating solution from a coating solution discharge member onto a substrate held by a rotary holding member to supply the coating solution onto a portion of a surface of the substrate; then capturing an image of the surface of the substrate; and specifying a discharge position of the coating solution discharge member on the surface of the substrate based on a position of a supply portion of the coating solution appearing in the image of the surface of the substrate, and adjusting the discharge position of the coating solution discharge member with respect to the rotary holding member based on the discharge position of the coating solution discharge member.

As described above, it is also suitable to capture the image of the substrate having a portion of the surface supplied with the coating solution from the coating solution discharge member, specify the discharge position of the coating solution discharge member from the position of the supply portion of the coating solution appearing in the image, and adjust the discharge position of the coating solution discharge member. In this case, since the real discharge position of the coating solution discharge member before adjustment can easily be specified from the image of the surface of the substrate, positional adjustment of the coating solution discharge member can be performed easily and accurately, whereby the positional adjustment of the coating solution discharge member can be performed in a short time. Further, positional adjustment with a high precision can be performed irrespective of the degree of proficiency of operator.

According to yet another aspect of the present invention, the present invention is a substrate processing system including: a coating treatment apparatus including a rotary holding member for holding and rotating a substrate, a coating solution discharge member for discharging a coating solution onto a center portion of the substrate rotated by the rotary holding member to apply the coating solution to a surface of the substrate, and a removal liquid discharge member for discharging a removal liquid for the coating solution onto an outer peripheral portion of the substrate rotated by the rotary holding member to remove the coating solution at the outer peripheral portion in an annular shape; an image capturing apparatus for capturing an image of the surface of the substrate; and a position adjusting apparatus for measuring a width of the outer peripheral portion of the substrate from which the coating solution has been removed by the removal liquid discharge member, from the image captured by the image capturing apparatus, deriving a positional displacement of a holding position of the substrate on the rotary holding member from the measured width of the outer peripheral portion, and adjusting the holding position of the substrate on the rotary holding member based on the positional displacement.

In this case, it is possible to apply the coating solution to the entire surface of the substrate and then remove only the coating solution at the outer peripheral portion of the substrate in an annular shape. Then, it is possible to capture the image of the surface of the substrate, measure from the captured image the width of the outer peripheral portion of the substrate from which the coating solution has been removed, derive from the width the positional displacement of the holding position of the substrate on the rotary holding member, and adjust the holding position of the substrate based on the positional displacement. In this case, since the displacement of the holding position of the substrate can be easily derived from the image of the substrate, positional adjustment can be performed in a shorter time. Further, since the holding position of the substrate can be adjusted from information of the image of the substrate, accurate positional adjustment can be performed irrespective of the degree of proficiency of operator.

According to further still another aspect of the present invention, the substrate processing system of the present invention includes: a coating treatment apparatus including a rotary holding member for holding and rotating a substrate, and a coating solution discharge member for discharging a coating solution onto a center portion of the substrate rotated by the rotary holding member to apply the coating solution to a surface of the substrate; a thickness distribution detector for detecting a thickness distribution of the coating solution on the surface of the substrate; and a position adjusting apparatus for specifying a discharge position of the coating solution discharge member on the surface of the substrate from the thickness distribution detected by the thickness distribution detector, deriving a positional displacement between the discharge position of the coating solution discharge member and a rotation center of the rotary holding member on the surface of the substrate, and adjusting the discharge position of the coating solution discharge member with respect to the rotary holding member based on the positional displacement.

In this case, it is possible to derive the positional displacement between the rotation center of the rotary holding member and the discharge position of the coating solution discharge member from the thickness distribution of the coating solution applied on the surface of the substrate, and adjust the discharge position of the coating solution discharge member based on the positional displacement. In this case, since positional adjustment of the coating solution discharge member can be performed by a relatively simple method, the positional adjustment can be performed in a short time. Further, since the discharge position of the coating solution discharge member can be adjusted from information of the thickness distribution of the coating solution detected by the thickness distribution detector, accurate positional adjustment can be performed irrespective of the degree of proficiency of operator.

According to another aspect of the present invention, the substrate processing system of the present invention includes: a coating treatment apparatus including a rotary holding member for holding and rotating a substrate, and a coating solution discharge member for discharging a coating solution onto the substrate rotated by the rotary holding member to supply the coating solution onto a portion of a surface of the substrate; an image capturing apparatus for capturing an image of the surface of the substrate; and a position adjusting apparatus for specifying a discharge position of the coating solution discharge member on the surface of the substrate based on a position of a supply portion of the coating solution appearing in the image of the surface of the substrate, and adjusting the discharge position of the coating solution discharge member with respect to the rotary holding member based on the discharge position of the coating solution discharge member.

In this case, it is possible to capture the image of the substrate having a portion of the surface supplied with the coating solution from the coating solution discharge member, specify the discharge position of the coating solution discharge member from the position of the supply portion of the coating solution appearing in the image, and adjust the discharge position of the coating solution discharge member with respect to the rotary holding member. In this case, since the real discharge position of the coating solution discharge member before adjustment can be easily specified from information of the image of the substrate surface, positional adjustment of the coating solution discharge member can be performed easily and accurately.

### BRIEF DESCRIPTION OF THE DRAWINGS

FIG. 1 is a plan view showing the outline of a configuration of a coating and developing treatment system in an embodiment;

FIG. 2 is a front view of the coating and developing treatment system in FIG. 1;

FIG. 3 is a rear view of the coating and developing treatment system in FIG. 1;

FIG. 4 is an explanatory view of a longitudinal section showing the outline of a configuration of a resist coating apparatus;

FIG. 5 is an explanatory view of a cross section showing the outline of the configuration of the resist coating apparatus;

FIG. 6 is an explanatory view of a longitudinal section showing the outline of a configuration of a defect detector;

FIG. 7 is an explanatory view showing an image of a wafer surface captured;

FIG. 8 is an explanatory view showing an appearance of the wafer surface when a holding position of the wafer is displaced;

FIG. 9 is an explanatory view showing measurement positions of the widths of a removal region on the wafer surface;

FIG. 10 is an explanatory view showing a thickness distribution on the wafer surface for specifying a discharge position of a resist solution discharge nozzle;

FIG. 11 is a plan view of a wafer showing a state in which a resist solution is supplied onto a portion of the wafer surface;

FIG. 12 is a plan view of a wafer for explaining a method for specifying the discharge position of the resist solution discharge nozzle; and

FIG. 13 is a plan view showing the outline of a configuration of a coating and developing treatment system when a buffer for housing a jig for positional adjustment is provided.

### DETAILED DESCRIPTION OF THE INVENTION

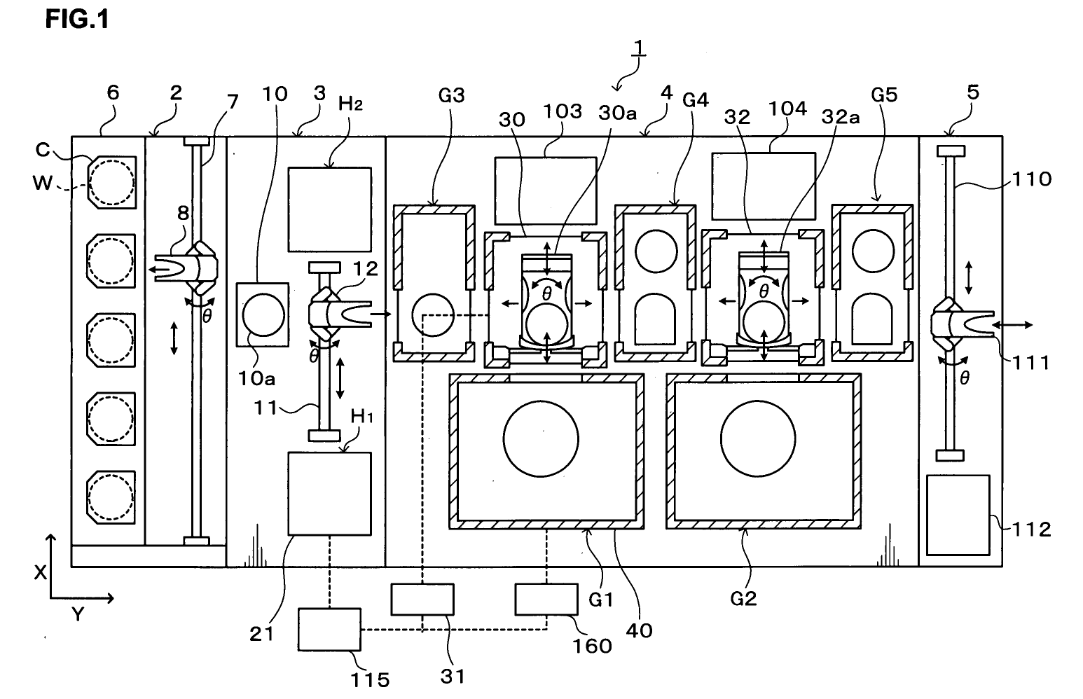

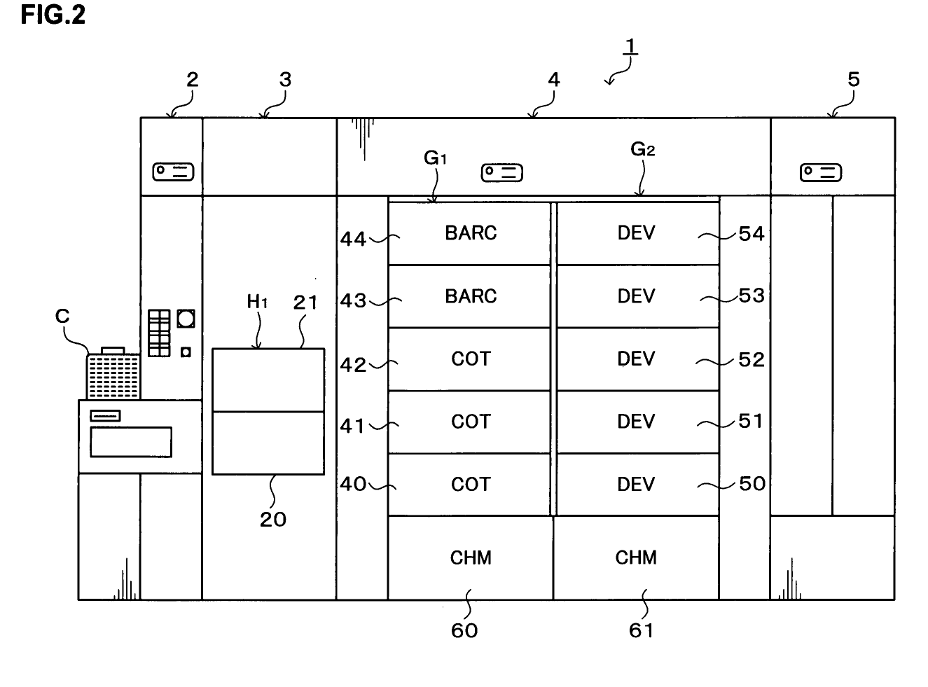

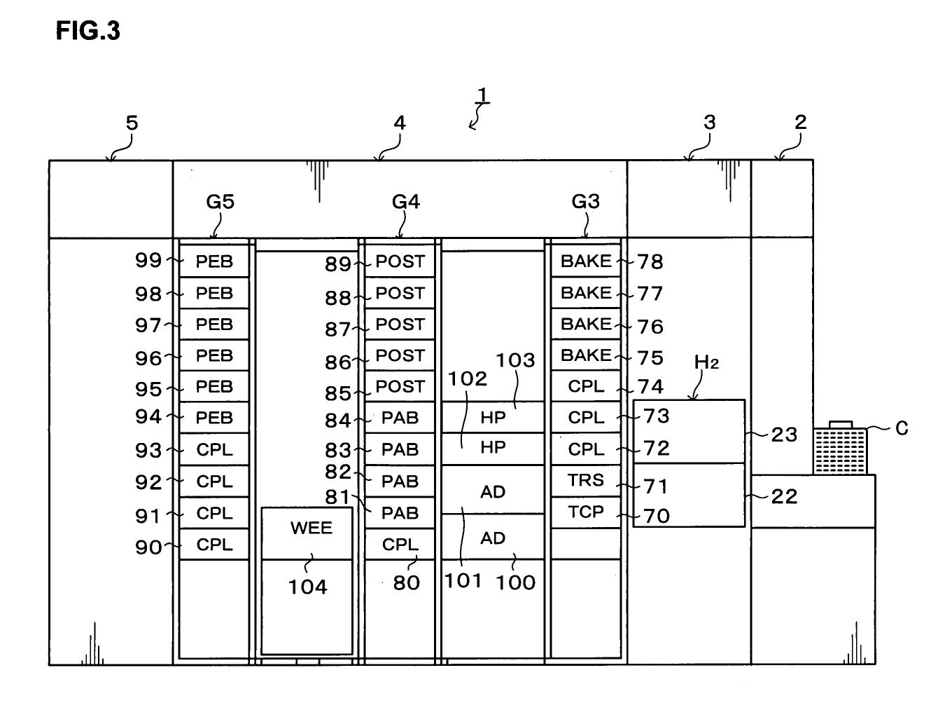

Hereinafter, a preferred embodiment of the present invention will be explained. FIG. 1 is a plan view showing the outline of a configuration of a coating and developing treatment system 1 as a substrate processing system according to this embodiment, FIG. 2 is a front view of the coating and developing treatment system 1, and FIG. 3 is a rear view of the coating and developing treatment system 1.

As shown in FIG. 1, the coating and developing treatment system 1 has a structure in which a cassette station 2 for carrying, for example, 25 wafers W per cassette, as a unit, from/to the outside into/out of the coating and developing treatment system 1 and carrying the wafers W into/out of a cassette C, an inspection station 3 for performing predetermined inspection on the wafers W, a processing station 4 constituted of multi-tiered various kinds of treatment and processing apparatuses each for performing predetermined treatment or processing in a manner of single wafer processing in coating and developing steps, and an interface section 5 for delivering the wafers W to/from a not-shown aligner provided adjacent to the processing station 4, are integrally connected.

In the cassette station 2, a plurality of cassettes C can be mounted at predetermined positions on a cassette mounting table 6 in a line in an X-direction (a top-to-bottom direction in FIG. 1). In the cassette station 2, a wafer carrier 8 is provided to be movable in the X-direction on a carrier path 7. The wafer carrier 8 is movable also in the vertical direction and thus can selectively access the wafers W arranged in the vertical direction in the cassette C. The wafer carrier 8 is rotatable around an axis (a θ-direction) in the vertical direction and thus can also get access to a later-described delivery unit 10 on the inspection station 3 side.

The inspection station 3 includes, for example, two measuring apparatus groups H1 and H2 in each of which a plurality of measuring apparatuses for inspection are multi-tiered. The first measuring apparatus group H1 is located, for example, on the side of a negative direction in the X-direction (the lower direction in FIG. 1) in the inspection station 3, and the second measuring apparatus group H2 is located, for example, on the side of a positive direction in the X-direction (the upper direction in FIG. 1) in the inspection station 3. On the cassette station 2 side in the inspection station 3, the delivery unit 10 is located for delivering the wafer W to/from the cassette station 2. The delivery unit 10 is provided with a mounting part 10a on which, for example, the wafer W is mounted. Between the first measuring apparatus group H1 and the second measuring apparatus group H2, a wafer carrier apparatus 12 movable along the X-direction, for example, on a carrier path 11. The wafer carrier apparatus 12 is, for example, movable in the vertical direction and also rotatable in the θ-direction to be able to get access to later-described measuring apparatuses in the measuring apparatus groups H1 and H2, the delivery unit 10, and later-described processing apparatuses in a third processing apparatus group G3 on the processing station 4 side.

In the first measuring apparatus group H1, for example, a line width measuring apparatus 20 for measuring the line width of a pattern formed on the wafer W and a defect detector 21 for detecting defects on the wafer surface are two-tiered in order from the bottom as shown in FIG. 2.

In the second measuring apparatus group H2, for example, a film thickness measuring apparatus 22 for measuring the film thickness of a film on the wafer W and an overlay measuring apparatus 23 for measuring the deviation in overlay in exposure are two-tiered in order from the bottom as shown in FIG. 3.

The processing station 4 includes, for example, five processing apparatus groups G1 to G5, as shown in FIG. 1, in each of which a plurality of processing apparatuses are multi-tiered. On the side of the negative direction in the X-direction (the lower direction in FIG. 1) in the processing station 4, the first processing apparatus group G1 and the second processing apparatus group G2 are placed in order from the inspection station 3 side. On the side of the positive direction in the X-direction (the upper direction in FIG. 1) in the processing station 4, the third processing apparatus group G3, the fourth processing apparatus group G4, and the fifth processing apparatus group G5 are placed in order from the inspection station 3 side.

Between the third processing apparatus group G3 and the fourth processing apparatus group G4, a first carrier unit 30 is provided. The first carrier unit 30 includes, for example, a wafer holding arm 30a which is rotatable in the θ-direction and movable in the horizontal direction and the vertical direction. The first carrier unit 30 can move the wafer holding arm 30a back and forth with respect to the apparatuses in the adjacent first processing apparatus group G1, third processing apparatus group G3, and forth processing apparatus group G4, thereby carrying the wafer W between the apparatuses. The operation of the first carrier unit 30 is controlled by, for example, a carrier unit controller 31. In the carrier unit controller 31, for example, the coordinates of a stop position of carriage destination of the wafer W are set, so that the carrier unit controller 31 can move the wafer holding arm 30a according to the set coordinates.

Between the fourth processing apparatus group G4 and the fifth processing apparatus group G5, a second carrier unit 32 is provided. The second carrier unit 32 includes a wafer holding arm 32a which is similar to that of the first carrier unit 30 and thus can selectively get access and carry the wafer W to the second processing apparatus group G2, the fourth processing apparatus group G4, and the fifth processing apparatus group G5.

As shown in FIG. 2, in the first processing apparatus group G1, solution treatment apparatuses each for supplying a predetermined treatment solution onto the wafer W to thereby perform treatment, for example, resist coating apparatuses 40, 41, and 42, as coating treatment apparatuses, each for applying a resist solution to the wafer W to form a resist film, and bottom coating apparatuses 43 and 44 each for forming an anti-reflection film which prevents reflection of light during exposure processing, are five-tiered in order from the bottom. In the second processing apparatus group G2, solution treatment apparatuses, for example, developing treatment apparatuses 50 to 54 each for performing developing treatment on the wafer W are five-tiered in order from the bottom. Further, chemical chambers 60 and 61 for supplying various kinds of treatment solutions to the solution treatment apparatuses in the processing apparatus groups G1 and G2 are provided at the lowermost tiers of the first processing apparatus group G1 and the second processing apparatus group G2, respectively.

As shown in FIG. 3, in the third processing apparatus group G3, for example, a temperature regulating apparatus 70, a transition apparatus 71 for passing the wafer W, high-precision temperature regulating apparatuses 72 to 74 each for heating the wafer W under temperature control with a high precision, and high-temperature thermal processing apparatuses 75 to 78 each for heating the wafer W at a high temperature, are nine-tiered in order from the bottom.

In the fourth processing apparatus group G4, for example, a high-precision temperature regulating apparatus 80, pre-baking apparatuses 81 to 84 each for heating the wafer W after the resist coating treatment, and post-baking apparatuses 85 to 89 each for heating the wafer W after the developing treatment are ten-tiered in order from the bottom.

In the fifth processing apparatus group G5, a plurality of thermal processing apparatuses each for thermally processing the wafer W, for example, high-precision temperature regulating apparatuses 90 to 93 and post-exposure baking apparatuses 94 to 99 each for heating the wafer W after exposure, are ten-tiered in order form the bottom.

As shown in FIG. 1, on the side of the positive direction in the X-direction of the first carrier unit 30, a plurality of processing apparatuses are arranged, for example, adhesion apparatuses 100 and 101 each for performing hydrophobic treatment on the wafer W and heating processing apparatuses 102 and 103 each for heating the wafer W being four-tiered in order from the bottom as shown in FIG. 3. As shown in FIG. 1, on the side of the positive direction in the X-direction of the second carrier unit 32, for example, an edge exposure apparatus 104 for selectively exposing only the outer peripheral portion of the wafer W is located.

In the interface section 5, as shown in FIG. 1, for example, a wafer carrier 111 moving on a carrier path 110 extending in the X-direction and a buffer cassette 112 are provided. The wafer carrier 111 is movable in the Z-direction and also rotatable in the 0-direction and thus can get access and carry the wafer W to the not-shown aligner adjacent to the interface section 5, the buffer cassette 112, and the fifth processing apparatus group G5.

In the coating and developing treatment system 1, for example, a controller 115 is provided as a position adjusting apparatus as shown in FIG. 1. The controller 115 can, for example, control the operation and change the setting on the operation of the processing apparatuses and the carrier units in the coating and developing treatment system 1. The controller 115 can, for example, change the set coordinates of the stop position of carriage destination of the wafer W in the carrier unit controller 31.

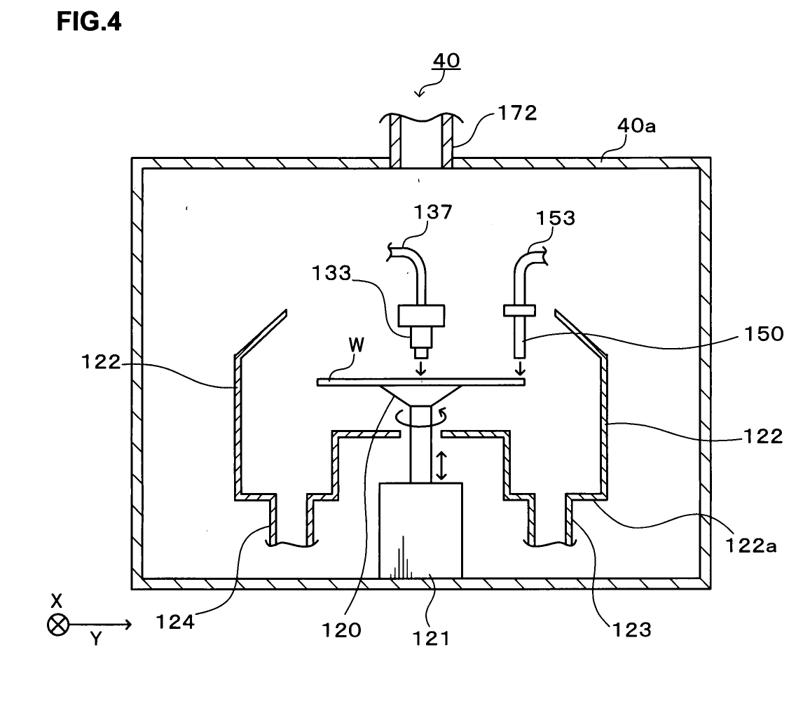

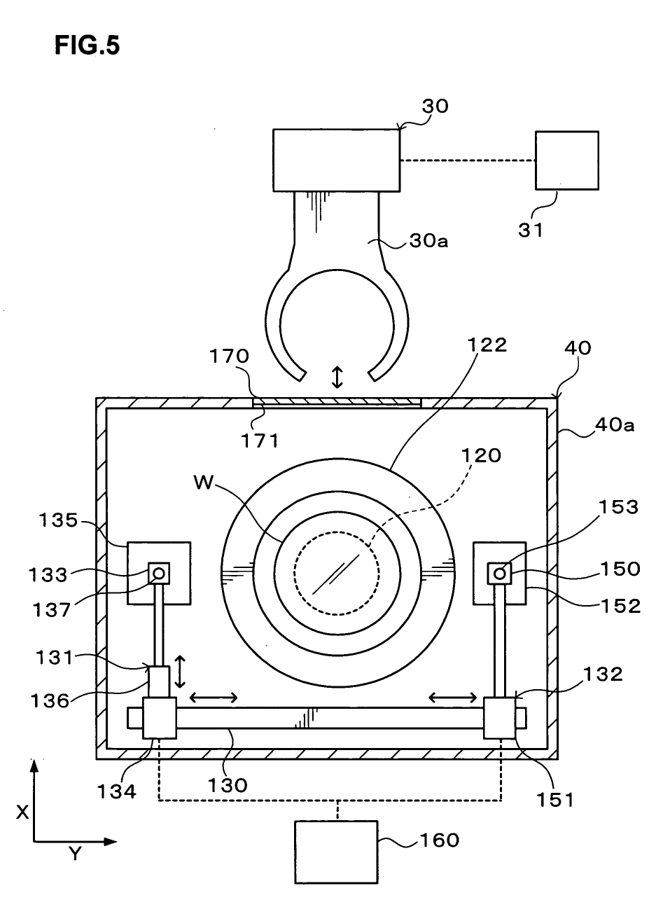

Next, the configuration of the above-described resist coating apparatus 40 will be described in detail. FIG. 4 is an explanatory view of a longitudinal section showing the outline of the configuration of the resist coating apparatus 40, and FIG. 5 is an explanatory view of a cross section of the resist coating apparatus 40.

The resist coating apparatus 40 has, as shown in FIG. 4, for example, a casing 40a in which a spin chuck 120 is provided at the center portion as a rotary holding member for holding and rotating the wafer W. The spin chuck 120 has a horizontal top face on which, for example, a suction port (not shown) is provided which sucks the wafer W. By suction through the suction port, the wafer W can be sucked onto the spin chuck 120.

The spin chuck 120 is provided with, for example, a chuck drive mechanism 121 for rotating and raising/lowering the spin chuck 120. The chuck drive mechanism 121 includes, for example, a rotation drive unit (not shown) such as a motor for rotating the spin chuck 120 at a predetermined speed, and a raising/lowering drive unit (not shown) such as a motor or a cylinder for raising/lowering the spin chuck 120. By means of the chuck drive mechanism 121, the wafer W on the spin chuck 120 can be raised/lowered at a predetermined timing and rotated at a predetermined speed.

Around the spin chuck 120, a cup 122 is provided for receiving and collecting a coating solution, a removal liquid, and so on scattered from the wafer W. The cup 122 has an almost cylindrical shape with an open top face and is formed in a manner to surround the outer side and bottom side of the wafer W on the spin chuck 120. At a bottom face 122a of the cup 122 is provided with a drain pipe 123 for draining the collected coating solution and so on and an exhaust pipe 124 for exhausting the cup 122.

As shown in FIG. 5, a rail 130 extending in a Y-direction (a right-to-left direction in FIG. 5) is provided on the side of a negative direction in an X-direction (a lower direction in FIG. 5) of the cup 122. The rail 130 is formed starting from the outside on the side of the negative direction in the Y-direction (a left direction in FIG. 5) of the cup 122 to the outside on the side of the positive direction in the Y-direction (a right direction in FIG. 5) of the cup 122. To the rail 130, two arms 131 and 132 are attached. On the first arm 131, a resist solution discharge nozzle 133 is supported as a coating solution discharge member. The first arm 131 is movable on the rail 130 in the Y-direction, for example, by means of a first drive mechanism 134 and thus can transfer the resist solution discharge nozzle 133 from a waiting section 135 placed at the outside of the cup 122 to a predetermined position inside the cup 122. The first arm 131 includes, for example, a second drive mechanism 136 for expanding/contracting the first arm 131 in the X-direction and thus can adjust the resist solution discharge nozzle 133 to a predetermined position in the X-direction. Note that the first arm 131 is movable also in the vertical direction, for example, by means of the first drive mechanism 134 and thus can raise/lower the resist solution discharge nozzle 133 to an arbitrary height.

The resist solution discharge nozzle 133 communicates with a not-shown resist solution supply source placed outside the resist coating apparatus 40 through a resist solution supply pipe 137 and thus can discharge downward the resist solution supplied from the resist solution supply source.

As shown in FIG. 5, on the second arm 132, a removal liquid discharge nozzle 150 is supported as a removal liquid discharge member for discharging a removal liquid for the resist solution onto the outer peripheral portion of the wafer W. The second arm 132 is movable on the rail 130 in the Y-direction, for example, by means of a third drive mechanism 151. Further, the second arm 132 is movable also in the vertical direction by means of the third drive mechanism 151. With the above configuration, the second arm 132 can transfer the removal liquid discharge nozzle 150 from a waiting section 152 provided at the outside on the side of the positive direction in the Y-direction of the cup 122 to a position above the outer peripheral portion of the wafer W inside the cup 122. The removal liquid discharge nozzle 150 communicates with a not-shown removal liquid supply source placed outside the resist coating apparatus 40 through a removal liquid supply pipe 153 and thus can discharge downward the removal liquid supplied from the removal liquid supply source.

The operations of the first drive mechanism 134, the second drive mechanism 136, and the third drive mechanism 151 are controlled by, for example, a coating apparatus controller 160. In the coating apparatus controller 160, for example, the coordinates of discharge position of the resist solution discharge nozzle 133 when it discharges the resist solution onto the wafer W and the coordinates of discharge position of the removal liquid discharge nozzle 150 when it discharges the removal liquid are set. The coating apparatus controller 160 can drive the drive mechanisms 134, 136, and 151 in accordance with the set coordinates to thereby move the resist solution discharge nozzle 133 and the removal liquid discharge nozzle 150. Various settings in the coating apparatus controller 160 can be changed by the above-described controller 115 of the coating and developing treatment system 1.

The side face on the side of the positive direction in the X-direction of the casing 40a is provided with a carrier port 170 for carrying in/out the wafer W. The carrier port 170 is provided with a shutter 171, and the shutter 171 is opened to allow the wafer holding arm 30a of the first carrier unit 30 to pass through the carrier port 170 so that the wafer W can be carried into the resist coating apparatus 40.

As shown in FIG. 4, to the top face of the casing 40a, a duct 172 is connected for introducing a gas, which has been adjusted in temperature and humidity and cleaned, and can introduce a predetermined gas in processing the wafer W to maintain a predetermined atmosphere in the casing 40a.

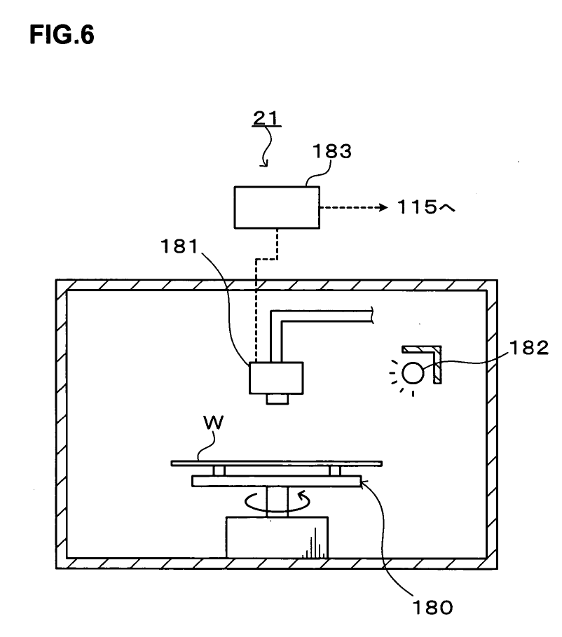

Next, the configuration of the defect detector 21 installed in the coating and developing treatment system 1 will be described. FIG. 6 is an explanatory view of a longitudinal section showing the outline of a configuration of the defect detector 21.

In a casing 21 a of the defect detector 21, a rotary mounting table 180 is provided which can horizontally hold the wafer W and also change its orientation. Above the rotary mounting table 180, a CCD camera 181 is provided as an image capturing member for capturing an image of the surface of the wafer W on the rotary mounting table 180. Beside the CCD camera 181, a black light 182 is provided as an irradiation member. The data of the image captured by the CCD camera 181 is outputted, for example, to a data processing unit 183. The data processing unit 183 can analyze the outputted image data to detect defects on the surface of the wafer W.

Further, for example, the data processing unit 183 can output the image data detected in the defect detector 21 to the controller 115 of the coating and developing treatment system 1 shown in FIG. 1. Based on the image data, the controller 115 can perform, for example, centering adjustment in the resist coating apparatus 40, for example, the holding position of the wafer W on the spin chuck 120, that is, the delivery position of the first carrier unit 30 to the spin chuck 120. For example, the controller 115 can measure, based on the image data outputted from the data processing unit 183, the width of the outer peripheral portion of the wafer W which has been formed by removing the resist solution by means of the removal liquid discharge nozzle 150 to calculate, from the width of the outer peripheral portion, the positional displacement of the holding position of the wafer W. Then, the controller 115 can change the set coordinates of the stop position of carriage destination of the wafer W in the carrier unit controller 31 so that, for example, the rotation center of the spin chuck 120 is aligned with the center of the wafer W. Note that the defect detector 21 serves as an image capturing apparatus in this embodiment.

Next, normal wafer processing will be described which is performed in the coating and developing treatment system 1 configured as described above. First, a single wafer W is taken out by the wafer carrier 8 shown in FIG. 1 from the cassette C on the cassette mounting table 6 and delivered to the delivery unit 10 in the inspection station 3. The wafer W delivered to the delivery unit 10 is carried by the wafer carrier apparatus 12 to the temperature regulating apparatus 70 included in the third processing apparatus group G3 in the processing station 4. The wafer W carried to the temperature regulating apparatus 70 is temperature-regulated and then carried by the first carrier unit 30, for example, to the bottom coating apparatus 43 in which an anti-reflection film is formed on the wafer W. The wafer W is further carried in sequence to the heating processing apparatus 102, the high-temperature thermal processing apparatus 75, and the high-precision temperature regulating apparatus 80, in each of which the wafer W is subjected to predetermined processing. Thereafter, the wafer W is carried by the first carrier unit 30 to the resist coating apparatus 40.

In this event, the wafer holding arm 30a of the first carrier unit 30 enters through the carrier port 170 shown in FIG. 5 to carry the wafer W to the predetermined position above the spin chuck 120. After the wafer W is carried to the predetermined position, the wafer W is sucked and held on the spin chuck 120. In this event, when the wafer W is held at an appropriate holding position on the spin chuck 120, the center of the wafer W is resultantly aligned with the rotation center of the spin chuck 120.

When the wafer W is sucked and held on the spin chuck 120, the first arm 131 moves to thereby move the resist solution discharge nozzle 133 waiting at the waiting section 135 to the discharge position above the center portion of the wafer W. Subsequently, for example, the wafer W is rotated by the spin chuck 120, and the resist solution discharge nozzle 133 discharges a predetermined amount of resist solution onto the center portion of the rotated wafer W. The resist solution discharged on the wafer W is spread by centrifugal force, whereby the resist solution is applied to the entire surface of the wafer W. Thereafter, the rotation speed of the wafer W is changed to scatter the excessive resist solution on the wafer W, so that a solution film of the resist solution (a resist film) with a predetermined thickness is formed on the wafer W.

Thereafter, when the first arm 131 retracts to the waiting section 135 and the rotation speed of the wafer W is changed, the second arm 132 moves to thereby move the removal liquid discharge nozzle 150 to a position above the outer peripheral portion of the wafer W and stops it there. Subsequently, the removal liquid discharge nozzle 150 discharges the removal liquid onto the outer peripheral portion of the rotated wafer W, so that the resist solution at the outer peripheral portion of the wafer W is removed in an annular shape.

When the resist solution at the outer peripheral portion of the wafer W is removed in the annular shape, the rotation of the wafer W is stopped, and the second arm 132 is returned to the waiting section 152. Thereafter, the wafer W is passed to the wafer holding arm 30a of the first carrier unit 30 and carried out of the resist coating apparatus 40, with which a series of resist coating treatment is completed.

After completion of the resist coating treatment, the wafer W is carried by the first carrier unit 30 to the pre-baking apparatus 81 in which it is subjected to heating processing, and then carried in sequence by the second carrier unit 32 to the edge exposure apparatus 104 and the high-precision temperature regulating apparatus 93, in each of which the wafer W is subjected to predetermined processing. Thereafter, the wafer W is carried by the wafer carrier 111 via the interface section 5 to the not-shown aligner in which a predetermined pattern is exposed on the resist film. The wafer W for which the exposure processing has been finished is returned again via the interface section 5 into the processing station 4. The wafer W is carried in sequence by the second carrier unit 32 to the post-exposure baking apparatus 94 and the high-precision temperature regulating apparatus 91, in each of which the wafer W is subjected to predetermined processing, and then the wafer W is carried into the developing treatment apparatus 50 and subjected to developing treatment.

The wafer W for which the developing treatment has been finished is carried by the second carrier unit 32 to the post-baking apparatus 85 and subjected to heating processing, and then carried by the first carrier unit 30 to the high-precision temperature regulating apparatus 72 and subjected to cooling processing. Thereafter, the wafer W is carried by the first carrier unit 30 to the transition apparatus 71 and then carried by the wafer carrier apparatus 12 to the defect detector 21 included in the first measuring apparatus group H1 of the inspection station 3.

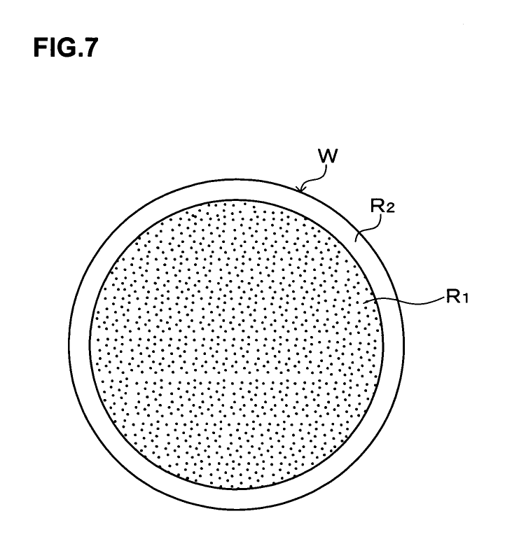

The wafer W carried into the defect detector 21 is mounted on the rotary mounting table 180 and rotated so that a notch portion of the wafer W faces in a predetermined direction. Thereafter, the black light 182 applies light to the wafer W, and the CCD camera 181 captures the entire image of the surface of the wafer W. The image obtained at this time is, for example, such that a coating region R1 in a circular shape of the resist solution is formed at the center portion on the surface of the wafer W and a resist solution removal region R2 is formed at the outer peripheral portion as shown in FIG. 7. The data of this image is outputted to and analyzed by the data processing unit 183, so that the presence or absence of defects on the surface of the wafer W is inspected.

The wafer W for which the defect inspection has been finished is carried in sequence into, for example, the line width measuring apparatus 20, and the film thickness measuring apparatus 22 and the overlay measuring apparatus 23 included in the second measuring apparatus group H2, in each of which the wafer W is subjected to predetermined measurement or inspection. The wafer W for which the inspection in the inspection station 3 has been finished is delivered by the wafer carrier apparatus 12 to the delivery unit 10 and is returned from the delivery unit 10 by the wafer carrier 8 into the cassette C, with which a series of processes in the coating and developing treatment system 1 is completed.

Next, wafer processing to perform centering adjustment in the resist coating apparatus 40 will be described. In a manner similar to the above-described normal wafer processing, a wafer W is taken out from the cassette C on the cassette mounting table 6 and delivered in sequence, for example, to the temperature regulating apparatus 70, the bottom coating apparatus 43, the heating processing apparatus 102, the high-temperature thermal processing apparatus 75, and the high-precision temperature regulating apparatus 80, in each of which the wafer W is subjected to predetermined processing, and thereafter the wafer W is carried to the resist coating apparatus 40. In the resist coating apparatus 40, a resist film is formed on the wafer W as in the above-described normal wafer processing, and then the resist solution at the outer peripheral portion of the wafer W is removed and immediately thereafter carried to the defect detector 21 included in the inspection station 3.

When the wafer W is carried into the defect detector 21, an image of the wafer surface is captured, and the data of the image of the wafer surface is outputted, for example, to the controller 115. The controller 115 measures from the image data the width of the resist solution removal region R2 shown in FIG. 7. The width measurement is performed at four points at 90° intervals, for example, at widths D1 and D2 at both ends of the wafer in the X-direction passing through the rotation center of the spin chuck 120 as seen in a plan view and at widths D3 and D4 at both ends of the wafer in the Y-direction.

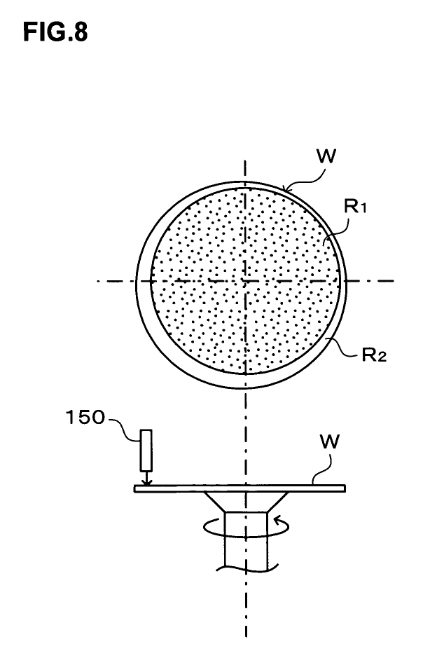

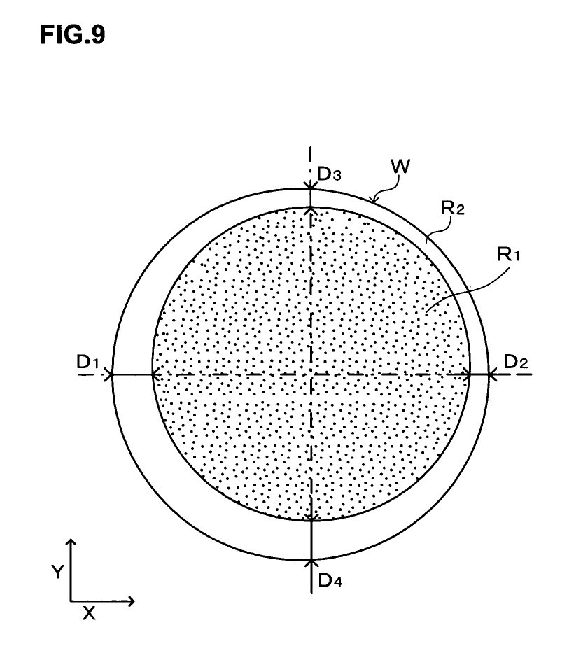

When the holding position of the wafer W is displaced from the rotation center of the spin chuck 120, for example, as shown in FIG. 8 during the coating treatment in the resist coating apparatus 40, the wafer W is rotated off center, resulting in uneven widths of the resist solution removed by the removal liquid discharge nozzle 150. The controller 115 measures the widths D1 to D4 as shown in FIG. 9 in this case and calculates the positional displacement amount of the wafer W.

For example, the positional displacement amount in the X-direction between the center of the wafer W and the rotation center of the spin chuck 120 is calculated from the width D1 and the width D2, and the positional displacement amount in the Y-direction between the center of the wafer W and the rotation center of the spin chuck 120 is calculated from the width D3 and the width D4. The controller 115 outputs the calculated positional displacement amounts in the X-direction and the Y-direction as correction values, for example, to the carrier unit controller 31, so that the set coordinates of the stop position of carriage destination of the wafer W with respect to the resist coating apparatus 40 are changed in the carrier unit controller 31. Thereby the stop position on the spin chuck 120 of the wafer W carried by the wafer holding arm 30a is corrected, whereby the holding position of the wafer W on the spin chuck 120 is adjusted.

According to the above embodiment, it is possible to measure the width of the removal region R2 at the outer peripheral portion of the wafer from the image of the wafer surface detected in the defect detector 21 and calculate from the width the positional displacement of the holding position of the wafer W in the resist coating apparatus 40. Then, based on the positional displacement, the holding position of the wafer W can be adjusted. In this case, since the centering adjustment in the resist coating apparatus 40 can be performed by a simple method, the centering adjustment can be performed quickly in a short time. This can increase, for example, the availability of the coating and developing treatment system 1. Further, since the centering adjustment is accurately performed using the image data, positional adjustment with a high accuracy can be performed at all-times.

In addition, the image data for use in the centering adjustment can be detected using the existing defect detector 21, thus avoiding the necessity for separately installing an apparatus exclusively used for detection of the positional displacement, in the coating and developing treatment system 1. This can consequently prevent an increase in size and cost of the coating and developing treatment system 1.

In the above-described embodiment, the wafer W which has been subjected to the coating treatment in the resist coating apparatus 40 is not carried to the developing treatment apparatus 50 and the aligner (not shown), but the wafer W with no pattern formed thereon is directly carried to the defect detector 21. Therefore, the measurement of the width of the removal region R2 on the wafer surface based on the image of the wafer surface is not affected by the shape and so on of a pattern, thus enabling accurate measurement of the width of the removal region R2. As a result of this, the centering adjustment can be accurately performed.

While the width of the removal region R2 on the wafer surface is measured at four points at 90° intervals in the above-describe embodiment, the number of points at regular intervals can also be arbitrarily selected.

Although the centering adjustment is performed on the holding position of the wafer W on the spin chuck 120 based on the image data of the wafer W detected in the defect detector 21 in the above embodiment, the centering adjustment may be performed on the resist solution discharge nozzle 133. An example of that case will be described below.

For example, the wafer to which the resist solution has been applied and the resist solution at the outer peripheral portion has been removed in the resist coating apparatus is carried into the defect detector 21. Then, the image of the wafer W is detected in the defect detector 21, and the image data is outputted to the controller 115. The controller 115 analyzes the image data to detect a thickness distribution of the resist solution on the wafer W.

The thickness distribution of the resist solution is detected, for example, by processing the image data and indicating the difference in the thickness of the resist solution by colors. When the discharge position of the resist solution discharge nozzle 133 is displaced from the rotation center of the spin chuck 120 during the resist coating, the thickness of the resist solution on the wafer surface corresponding to the discharge position differs from that at the other portions. It can be supposed that this is because a slightly larger amount of resist solution is supplied to the discharge position on the wafer surface than that to the other portions, whereby the thickness of the resist solution at the discharge position becomes slightly larger than at the other portions.

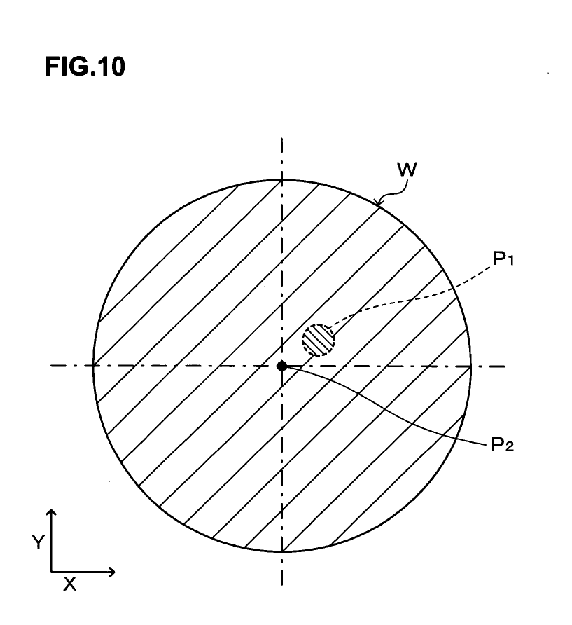

As a result of this, as shown in FIG. 10, a discharge position P1 of the resist solution discharge nozzle 133 on the wafer surface is displayed, in terms of the thickness distribution, in a color different from that at the other portions. Further, a rotation center P2 of the spin chuck 120 during the resist coating is adjusted to be aligned with the center position of the rotary mounting table 180, for example, when the wafer W is mounted on the rotary mounting table 180.

The controller 115 specifies the discharge position P1 of the resist solution discharge nozzle 133 from the color indicating the thickness distribution and calculates the positional displacement amounts in the X-direction and the Y-direction between the discharge position P1 and the rotation center P2 of the spin chuck 120. The controller 115 outputs the calculated positional displacement amounts in the X-direction and the Y-direction as correction values to the coating apparatus controller 160. In the coating apparatus controller 160, the set coordinates of the stop position of the resist solution discharge nozzle 133 at the time of discharging the resist solution are changed based on the correction values. In this manner, the discharge position P1 of the resist solution discharge nozzle 133 at the time of discharging the resist solution is adjusted to be on the rotation center P2 of the spin chuck 120.

In this case, since the centering adjustment of the resist solution discharge nozzle 133 is performed based on the image data by the defect detector 21, the centering adjustment is relatively easily performed. Therefore, the time required for the centering adjustment can be shortened, resulting in improved availability of the coating and developing treatment system 1. Further, since accurate positional adjustment can be performed based on the image data of the wafer surface, positional adjustment with a high accuracy can be performed at all times. Note that the defect detector 21 serves as a thickness distribution detector in this embodiment.

The thickness distribution of the resist solution on the wafer surface can be changed by changing the rotation speed of the wafer W in the resist coating apparatus 40. In the above-described embodiment, the rotation speed of the wafer W may be controlled when the resist solution is applied to the wafer W in the resist coating apparatus 40 so that the difference between the thickness of the resist solution at the discharge position P1 of the resist solution discharge nozzle 133 and the thickness at the other portions becomes larger. In this case, the difference in color at the discharge position P1 within the thickness distribution becomes clearer when the discharge position P1 of the resist solution discharge nozzle 133 is specified from the thickness distribution on the surface of the wafer W in the defect detector 21. Therefore, the discharge position P1 can be easily and accurately specified, leading to accurate positional adjustment of the resist solution discharge nozzle 133.

Alternatively, the rotation speed of the wafer W in the resist coating apparatus 40 may be controlled so that the thickness of the resist solution at the rotation center P2 of the spin chuck 120 on the surface of the wafer W differs from the thickness at the other portions. In this case, the thickness distribution of the resist solution on the wafer surface is detected in the defect detector 21, whereby the discharge position P1 of the resist solution discharge nozzle 133 on the wafer surface and the rotation center P2 of the spin chuck 120 can be specified from the difference in color within the thickness distribution. Then, the positional displacement amounts in the X-direction and the Y-direction between the discharge position P1 and the rotation center P2 are calculated so that the discharge position of the resist solution discharge nozzle 133 can be adjusted based on the positional displacement amounts.

The thickness distribution of the resist solution is detected by the defect detector 21 in the above-described embodiment, but may be detected by another apparatus, for example, the film thickness measuring apparatus 20. In the film thickness measuring apparatus 20, the thickness of a solution film of the resist solution can be measured, for example, by applying predetermined light onto the wafer W and detecting and analyzing its reflected light.

While the coating solution is discharged onto the entire surface of the wafer surface in the resist coating apparatus 40 and the discharge position P1 of the resist solution discharge nozzle 133 is specified from the thickness distribution of the resist solution in the above-described embodiment, the resist solution may be supplied onto a portion of the wafer surface from the resist solution discharge nozzle 133 in the resist coating apparatus 40 so that the discharge position P1 of the resist solution discharge nozzle 133 may be specified based on the position of the supply portion on the wafer surface.

In this case, for example, a predetermined amount of resist solution is supplied onto the wafer W on the spin chuck 120 from the resist solution discharge nozzle 133 located at a position set as the discharge position in the resist coating apparatus 40. In this event, the wafer W is not rotated or being rotated at a very low speed so that the resist solution discharged on the wafer W is not spread over the entire wafer surface.

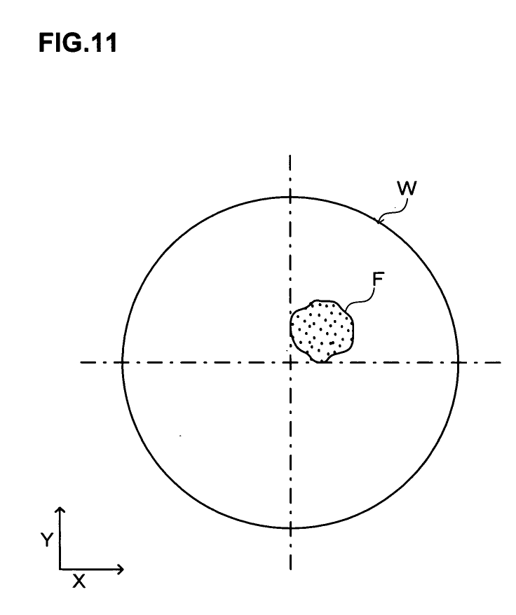

As a result, as shown in FIG. 11, the resist solution is supplied onto a portion on the wafer W to form a supply portion F of the resist solution on the wafer surface. The wafer W supplied with the resist solution in the resist coating apparatus 40 is carried into the defect detector 21 in which an image of the wafer surface is captured. The information of the image is processed, for example, in the controller 115, and the discharge position P1 of the resist solution discharge nozzle 133 is specified, for example, based on the position on the wafer surface of the supply portion F appearing in the image.

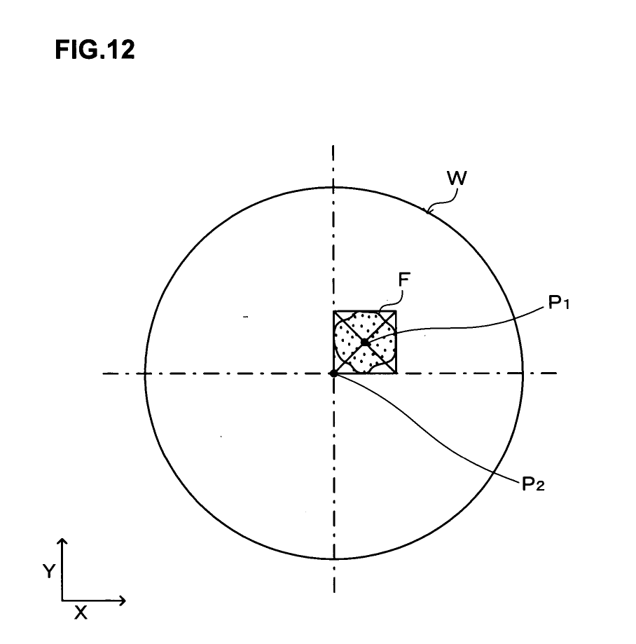

The discharge position P1 of the resist solution discharge nozzle 133 is specified by, for example, surrounding the outer edge portion of the supply portion F in a quadrangular shape by using four straight lines in the X- and Y-directions as shown in FIG. 12 and regarding a position where diagonal lines of the quadrangular shape intersect with each other as the discharge position P1. When the discharge position P1 of the resist solution discharge nozzle 133 is specified, for example, the positional displacement amount between the discharge position P1 and the rotation center P2 of the spin chuck 120 on the wafer surface is calculated, so that positional adjustment of the resist solution discharge nozzle 133 is performed based on the positional displacement amount. In this case, the discharge position P1 of the resist solution discharge nozzle 133 can be easily specified, leading to accurate positional adjustment.

In the above-described embodiment, both or only one of the above-described positional adjustment of the holding position of the wafer W and positional adjustment of the discharge position of the resist solution discharge nozzle 133 may be performed based on the image of the wafer W detected by the defect detector 21. In addition, when the positional adjustment on the resist coating apparatus 40 is performed, the wafer W which has been subjected to the coating treatment in the resist coating apparatus 40 may be carried to the developing treatment apparatus 50 and the aligner in which a pattern is formed on the wafer W as in the normal wafer processing, and then may be carried to the defect detector 21. In this case, the positional adjustment on the resist coating apparatus 40 can be performed during the normal wafer processing.

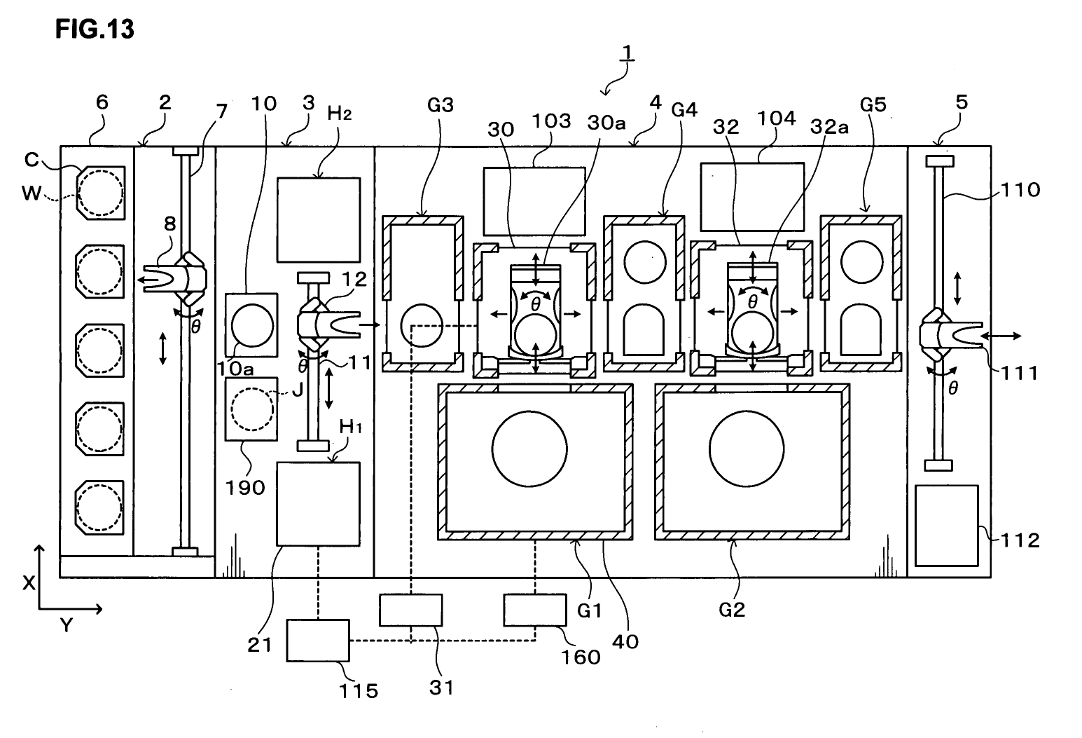

In the above-described embodiment, the wafer carried to the coating and developing treatment system 1 when the centering adjustment is performed may be the normal wafer W being a product or, for example, a jig for positional adjustment having the same shape as that of the wafer W. Further, the jig for positional adjustment may be installed in the coating and developing treatment system 1 in advance. In this case, for example, a buffer 190 as a jig housing unit which houses a jog J for positional adjustment may be provided at a position to which the wafer carrier apparatus 12 of the inspection station 3 can get access as shown in FIG. 13. Further, this buffer 190 may be provided in the first measuring apparatus group H1 which is the same group in which the defect detector 21 is included.

Further, the positional adjustment described in the above embodiment may be periodically performed during the operation of the coating and developing treatment system 1 or may be performed to coincide with the time of start or maintenance of the resist coating apparatus 40.

The above embodiment illustrates an example of the present invention, and the present invention is not limited to the example but can take various forms. For example, the coating and developing treatment system 1 described in the above embodiment may be one having other configurations in the kinds, number, and arrangement of the apparatuses and units. Besides, the present invention is applied to the positional adjustment on the resist coating apparatus for applying the resist solution in the above-described embodiment, and may also be applied to the positional adjustment on a coating treatment apparatus for applying to the wafer W other coating solutions, for example, an anti-reflection film solution for forming an anti-reflection film, SOD (Spin on Dielectric) and SOG (Spin on Glass) for forming an interlayer insulating film, and polyimide for forming a polyimide film. Further, the present invention is also applicable to other substrates, for example, an FPD (flat panel display) substrate, a mask substrate, and a reticle substrate, in addition to the wafer.

The present invention is useful, in a coating treatment apparatus which applies a coating solution to a substrate, in performing quickly and accurately positional adjustment of a holding position of the substrate in a rotary holding member and a discharge position of the coating solution.

1. A position adjusting method in a coating treatment apparatus comprising a rotary holding member and a coating solution discharge member, comprising the steps of:
discharging a coating solution from the coating solution discharge member onto a center portion of a substrate and spreading the coating solution over a surface of the substrate while holding and rotating the substrate by the rotary holding member to thereby apply the coating solution to the surface of the substrate;
then supplying a removal liquid for the coating solution onto an outer peripheral portion of the substrate from a removal liquid discharge member at a predetermined position while rotating the substrate by the rotary holding member to thereby remove the coating solution at the outer peripheral portion in an annular shape;
then capturing an image of the surface of the substrate; and
measuring a width of the outer peripheral portion from which the coating solution has been removed, from the image of the surface of the substrate, deriving a positional displacement of a holding position of the substrate on the rotary holding member from the measured width of the outer peripheral portion, and adjusting the holding position of the substrate based on the positional displacement.

2. The position adjusting method as set forth in claim 1,
wherein the measurement of the width of the outer peripheral portion is performed at both ends of the substrate in two predetermined directions perpendicular to each other on the substrate as seen in a plan view.

3. A position adjusting method in a coating treatment apparatus comprising a rotary holding member and a coating solution discharge member, comprising the steps of:
discharging a coating solution from the coating solution discharge member onto a center portion of a substrate and spreading the coating solution over a surface of the substrate while holding and rotating the substrate by the rotary holding member to thereby apply the coating solution to the surface of the substrate;
then detecting a thickness distribution of the coating solution on the surface of the substrate; and
specifying a discharge position of the coating solution discharge member on the surface of the substrate from the detected thickness distribution, deriving a positional displacement between the discharge position of the coating solution discharge member and a rotation center of the rotary holding member on the surface of the substrate, and adjusting the discharge position of the coating solution discharge member with respect to the rotary holding member based on the positional displacement.

4. The position adjusting method as set forth in claim 3,
wherein an image of the surface of the substrate is captured, and the thickness distribution of the coating solution is detected from information of the captured image.

5. A position adjusting method in a coating treatment apparatus comprising a rotary holding member and a coating solution discharge member, comprising the steps of:
discharging a predetermined amount of coating solution from the coating solution discharge member onto a substrate held by the rotary holding member to supply the coating solution onto a portion of a surface of the substrate;
then capturing an image of the surface of the substrate; and
specifying a discharge position of the coating solution discharge member on the surface of the substrate based on a position of a supply portion of the coating solution appearing in the image of the surface of the substrate, and adjusting the discharge position of the coating solution discharge member with respect to the rotary holding member based on the discharge position of the coating solution discharge member.

6. A substrate processing system for processing a substrate, comprising:
a coating treatment apparatus including a rotary holding member for holding and rotating the substrate, a coating solution discharge member for discharging a coating solution onto a center portion of the substrate rotated by said rotary holding member to apply the coating solution to a surface of the substrate, and a removal liquid discharge member for discharging a removal liquid for the coating solution onto an outer peripheral portion of the substrate rotated by said rotary holding member to remove the coating solution at the outer peripheral portion in an annular shape;
an image capturing apparatus for capturing an image of the surface of the substrate; and
a position adjusting apparatus for measuring a width of the outer peripheral portion of the substrate from which the coating solution has been removed by said removal liquid discharge member, from the image captured by said image capturing apparatus, deriving a positional displacement of a holding position of the substrate on said rotary holding member from the measured width of the outer peripheral portion, and adjusting the holding position of the substrate on said rotary holding member based on the positional displacement.

7. The substrate processing system as set forth in claim 6, wherein said image capturing apparatus is a defect detector for capturing the image of the surface of the substrate to detect a defect on the surface of the substrate.

8. A substrate processing system for processing a substrate, comprising:
a coating treatment apparatus including a rotary holding member for holding and rotating the substrate, and a coating solution discharge member for discharging a coating solution onto a center portion of the substrate rotated by said rotary holding member to apply the coating solution to a surface of the substrate;
a thickness distribution detector for detecting a thickness distribution of the coating solution on the surface of the substrate; and
a position adjusting apparatus for specifying a discharge position of said coating solution discharge member on the surface of the substrate from the thickness distribution detected by said thickness distribution detector, deriving a positional displacement between the discharge position of said coating solution discharge member and a rotation center of said rotary holding member on the surface of the substrate, and adjusting the discharge position of said coating solution discharge member with respect to said rotary holding member based on the positional displacement.

9. The substrate processing system as set forth in claim 8, wherein said thickness distribution detector is capable of capturing an image of the surface of the substrate to detect the thickness distribution of the coating solution from information of the captured image.

10. The substrate processing system as set forth in claim 9,
wherein said thickness distribution detector is a defect detector for capturing the image of the surface of the substrate to detect a defect on the surface of the substrate.

11. A substrate processing system for processing a substrate, comprising:
a coating treatment apparatus including a rotary holding member for holding and rotating the substrate, and a coating solution discharge member for discharging a coating solution onto the substrate rotated by said rotary holding member to supply the coating solution onto a portion of a surface of the substrate;
an image capturing apparatus for capturing an image of the surface of the substrate; and
a position adjusting apparatus for specifying a discharge position of said coating solution discharge member on the surface of the substrate based on a position of a supply portion of the coating solution appearing in the image of the surface of the substrate, and adjusting the discharge position of said coating solution discharge member with respect to said rotary holding member based on the discharge position of said coating solution discharge member.
